(19) United States
(12) Patent Application Publication
(10) Pub. No.: US 2019/0023566 A1
(43) Pub. Date: Jan. 24, 2019

(54) METHOD FOR RELEASING HYDOGEN, USE THEREOF AND VEHICLE FOR SAME

(71) Applicant: Hanspeter WEBER, Zollikofen (BE)

(72) Inventor: Hanspeter WEBER, Zollikofen (CH)

(21) Appl. No.: 15/757,630

(22) PCT Filed: Sep. 2, 2016
(86) PCT No.: PCT/CH2016/000114

§ 371 Date: Mar. 5, 2018

(30) Foreign Application Priority Data
Sep. 8, 2015 (CH) 01296/15

(51) Int. Cl. C01B 3/06; C01B 3/08; C25B 1/02; C25B 1/14

(52) U.S. Cl. CPC C01B 3/065; C01B 3/08; B60L 11/1883; C25B 1/14; C25B 1/02

(57) ABSTRACT

The invention relates to methods for generating hydrogen for use as an energy source by contacting a proton-delivery liquid with at least one metal hydride or one metal, selected from a metal hydride or a metal or an admixture of metals or metal hydrides, where the at least one metal hydride or metal selected and conditions of contact, namely the temperature, are set in such a way that a spontaneous reaction occurs that releases hydrogen. Alternatively, a method for generating hydrogen for use as an energy source where a metal hydride is heated at a raised temperature where the metal hydride releases hydrogen. Furthermore, the invention relates to vehicles and power stations that use hydrogen as an energy source.

### CROSS REFERENCE TO RELATED APPLICATIONS

This application claims the benefit to PCT/CH2016/000114, filed on Sep. 2, 2016, which claims the priority of CH 01296/15, filed on Sep. 8, 2015, the entire contents of which are incorporated herein by reference.

### FIELD OF INVENTION

This invention concerns a process for releasing hydrogen. It concerns furthermore an application for the hydrogen released and a vehicle for this application.

### BACKGROUND

The storage and use of elemental hydrogen for the purpose of propulsion in vehicles and for heating buildings and reactor vessels has been very problematic, as this medium requires a volume of energy source on the order of a hundred times that of oil at standard temperatures and pressures. Furthermore, pressure vessels with cooling units have been essential for storage and use for hydrogen energy sources.

It is therefore the intention of the present invention to provide a process for releasing hydrogen that originates from substances occupying a smaller volume, to enable a use of hydrogen for storing energy that is efficient and viable in practice.

### SUMMARY OF INVENTION

The invention relates to methods for generating hydrogen for use as an energy source from contacting a proton-delivery liquid with at least one metal hydride or one metal, selected from a metal hydride or a metal or an admixture of metals or metal hydrides, where the at least one metal hydride or metal selected and conditions of contact, namely the temperature, are set in such a way that a spontaneous reaction occurs that releases hydrogen. Alternatively, a method for generating hydrogen for use as an energy source where a metal hydride is heated at a raised temperature where the metal hydride releases hydrogen.

In one embodiment, the method of generating hydrogen for use as an energy source further comprising wherein the metal and metal hydride are selected from one or more of the following: lithium, sodium, potassium, lithium hydride sodium hydride, potassium hydride, magnesium dihydride, calcium hydride and, preferably, sodium or sodium hydride.

In another embodiment, the method of generating hydrogen for use as an energy source further comprising wherein the proton-delivering liquid is water or a lower alkyl alcohol, preferably a one to four carbon atom alcohol, and most preferable methanol or ethanol.

In another embodiment, the method of generating hydrogen for use as an energy source further comprising wherein the combined volume of the not less than one metal hydride, preferably sodium hydride, or not less than one metal, preferably sodium, and the proton-delivering liquid are at most 20 times the volume a hydrocarbon fuel with a calorific value of 40 MJ/kg. More preferably, the combined volume of the not less than one metal hydride, preferably sodium hydride, or not less than one metal, preferably sodium, and the proton-delivering liquid are at most 8 times the volume a hydrocarbon fuel with a calorific value of 40 MJ/kg.

In another embodiment, the method comprising wherein the metal cation-containing substance emerging from the at least one metal hydride or the at least one metal following the release of hydrogen, at least one metal or at least one metal hydride is produced by electrolysis.

In another embodiment, the method comprising wherein the metal cations are sodium cations, the sodium cation-containing substance is sodium hydroxide except for impurities, the sodium hydroxide is separated from the caustic soda and the sodium hydroxide is subjected to fused-salt electrolysis.

In another embodiment, the method comprising the electric power for the electrolysis is generated from a renewable energy source or from solar energy using solar panels.

In another embodiment, the method comprising wherein the volume of metal hydride, from which hydrogen is released with increased temperature, is not greater than 5 times, and preferably not greater than 3.5 times, the volume of a fuel basically consisting of hydrocarbons for a combustion engine with a calorific value of 40 MJ/kg.

In another embodiment, the method comprising wherein the at least one metal hydride is magnesium hydride and the raised temperature is set at least 250° C., preferably around 284° C., to release hydrogen.

In another embodiment, the method wherein the hydrogen energy released is used to fuel combustion engines in vehicles, to heat buildings or reactors (especially reactors in the chemicals industries), to generate power by burning in thermal power stations, or in electrochemical applications, particularly in fuel cells.

In another aspect of the invention, the invention is a vehicle that uses hydrogen as an energy source comprising a tank for the at least one metal or metal hydride, a second tank for the proton-delivering liquid, a third tank for the substance resulting from hydrogen generation and a reaction chamber for the reaction of the at least one metal or metal hydride with the liquid or the heating of the metal hydride at the increased temperature for hydrogen release.

In one embodiment of the vehicle, the reaction chamber in the vehicle comprises a portion or is entirely contained in the first or third tank.

In another embodiment of the vehicle, the first and third tanks and the reaction chamber in the vehicle represent one unit, so that the at least one metal or metal hydride can be converted into the substance without the at least one metal or metal hydride on the one hand and the substance on the other hand having to be moved between the tanks and the reaction chamber.

The idea of this invention was originally to bind the hydrogen atom to another atom in order to obtain a substance with a higher density and higher melting and boiling point.

The inventor arrived at a method of using elemental sodium or sodium hydride. The method breaks down water and releases hydrogen. In a preferred design the resulting sodium hydroxide is re-used in a recycling process, whereby the loop is closed.

### BRIEF DESCRIPTION OF FIGURES

FIG. 1. Solubility of sodium hydroxide (caustic soda) in water depending on temperature.

FIG. 2. Diagram: Energy generation

### DETAILED DESCRIPTION OF THE INVENTION

The necessary storage volumes of the source materials under normal pressure and at normal temperature are on the order of 7 to 20 times the comparable calorific value of oil, particularly a fuel obtained from oil. This is a viable starting point for the use of this energy source in practice.

The process described enables the switching of energy generation from nuclear energy and fossil fuels.

Enough energy can be generated from solar radiation to cover current electricity demand.

The sodium hydroxide by-product is re-used once thickened by fused-salt electrolysis of sodium hydroxide. This electrolysis forms a reservoir from the total energy generated to the total energy used.

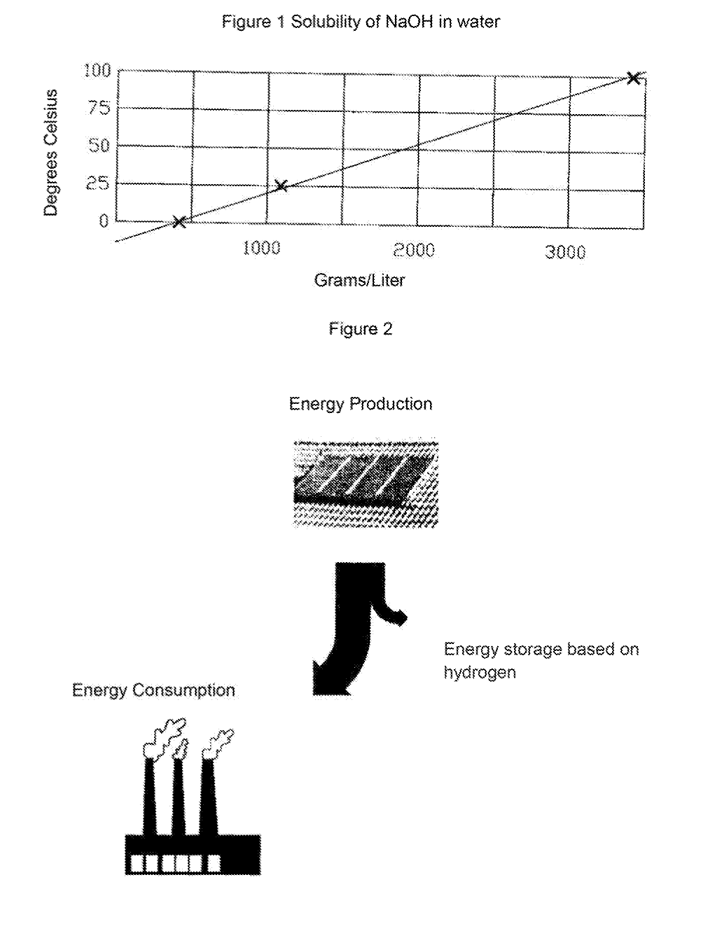

The data for figures in round brackets below concerns the formulae and chemical equations in the section “Implementation of the invention's design example”. The data for figures in square brackets concerns the citation reference numbers in the literature (see below).
(1) [1] Page 1275
(1B) According to rounded mol numbers reference [1] Table 1
(2) Reference [1] Page 1280. The energy released is calculated on the basis of the enthalpy of formation of sodium hydride (reference [1] Page 1279)
(2B) According to rounded mol numbers reference [1] Table 1
(3) Reference [1] Page 50
(3B) According to rounded mol numbers reference [1] Table 1
(3C) Results from (3B)
Table 1 Reference [1] Page 1284
FIG. 1 Results directly from Table 1
(5) Energy required is calculated from the enthalpy of formation of sodium hydride (reference [1] Page 1279) and that of sodium hydroxide (reference [1] Page 1284)
(6) Density of diesel fuel (reference [2] Z5)
   Calorific value of diesel fuel (reference [2] Z10)
   Formula input according to (reference [2] 02)
(6B) No further explanation necessary
(7) Explained in the text
(8) [2] O1
(9) No further explanation necessary
(10) Density Sodium (reference [3] Page 4-89)
(11) No further explanation necessary
(12) Density water (reference [3] Page 4-98)
(13) No further explanation necessary
(14) Density sodium hydride (reference [3] 4-90)
(15) No further explanation necessary
(16) Density water ([3] Page 4-98)
(17) No further explanation necessary
(18) No further explanation necessary
(19) No further explanation necessary
(20) No further explanation necessary
Table 2 Values calculated from data of reference [5], File shopdwhdata_5YD_BER
Table 3 and all information taken from reference [4] Section 4.4

### EXAMPLES

### Implementation of the Invention's First Design Example

The Hydrogen Generation Process

Variant A

Elementary sodium is stored in a first tank. Water is stored in a second vessel. The following reaction releases hydrogen (see reference [1]):

2Na+2H₂O→2NaOH+H2+282 kJ (1)

On the substances listed in equation (1) the respective mass is specified below in kg according to its rounded molar mass:

46 kg+36 kg→80 kg+2 kg+282MJ (1B)

The sodium hydroxide formed is further dissolved into sodium hydroxide with surplus water giving off heat (see recycling process).

Variant B

Sodium hydride (NaH) is stored in a first tank. Water is stored in a second vessel. Hydrogen is released through the following reaction (see reference [1]):

NaH+H₂O→NaOH+H₂+84 kJ (2)

On the substances listed in equation (2) the respective masses are specified below in kg according to their rounded molar mass:

24 kg+18 kg→40 kg+2 kg+84 MJ (28)

The sodium hydroxide formed reacts further to sodium hydroxide with surplus water giving off heat (see recycling process).

Hydrogen Recovery Process

If hydrogen is burnt, this takes place according to the following equation (see reference [1]):

$${H}_{2} + 1 \text{/} 2 O 2 \to {H}_{2} O + {286 kJ f}_{242 kJ g} \qquad ( 3 )$$

Here the energy value marked f signifies the enthalpy of reaction for water in its liquid state and that of g that for water in a gaseous state (water vapour).

For the substances listed in equation (3) the mass is specified below in kg according to its rounded molar mass:

2 kg+16 kg→18 kg+242MJ (3B)

And (3B) converted to 1 kg hydrogen:

1 kg+8 kg→9 kg+121 MJ (3C)

This hydrogen can be burnt in combustion engines or turbines or even just for heating, where the oxygen required for this is preferably taken from the atmosphere. Another option consists of using fuel cells to recover electrical energy.

The Recycling Process

As follows from equations (1) and (2), sodium hydroxide (NaOH) results from the release of hydrogen in both variants. This “caustic soda” is dissolved with surplus water into sodium hydroxide (NaOH_{aq}) with the hydrogen generation process.

The following table indicates solubility at three temperatures:

TABLE 1

| | Solubility sodium hydroxide in gram/liter |
|---|---|
| Degrees Celsius | water |
| 0 | 420 |
| 25 | 1090 |
| 100 | 3420 |

Here energy of 42.9 kJ per mol of sodium hydroxide is released. FIG. 1 shows that the solubility values can be interpolated roughly linearly over the temperature range.

In the recycling process solid sodium hydroxide must first be recovered from the sodium hydroxide solution by thickening. This can then be broken down into its elements again through fused-salt electrolysis, as described in the literature (Castner procedure). The melting point of caustic soda here is 318 degrees Celsius (see reference [1]).

Variant a (Recovery of Sodium from Sodium Hydroxide)

2NAOH→2 Na+O2+H₂ 854 kJ (4)

The hydrogen resulting from the fused-salt electrolysis is amalgamated with a percentage of the oxygen also resulting and recycled in a fuel cell or thermal engine. The other percentage of oxygen is emitted into the atmosphere. The resulting metallic sodium is stored in a tank.

The loop is thereby closed to the hydrogen generation process.

Variant B (Recovery of Sodium Hydride from Sodium Hydroxide)

NAOH→NaH+½O2−370 kJ (5)

The oxygen resulting from the fused-salt electrolysis is emitted into the atmosphere. The resulting hydrogen is once more conducted via the liquid sodium at a temperature of 250 to 300 degrees Celsius, leading to the formation of sodium hydride. Reference [1] This sodium hydride is stored in a tank.

The loop is thereby closed to the hydrogen generation process.

Comparative Calculation

A comparative calculation is conducted to illustrate the benefit of the invention. It is assumed from a current highly developed diesel engine used in a car and consuming 6 litres of diesel fuel for a distance of 100 kilometres.

The calorific value of 6 litres of diesel fuel is:

$$\begin{matrix}EDiesel = VDiesel \cdot ρ Diesel \cdot HuDiesel & ( 6 ) \\ 6 \cdot 0.83 \cdot 42.1 = 210 {dm}^{3} \cdot \frac{kg}{{dm}^{3}} \cdot \frac{MJ}{kg} = MJ & ( 6 B )\end{matrix}$$

On the basis of (3C) and (68) how much hydrogen corresponds to this 6 litres of diesel fuel is calculated:

$$\frac{210}{121} = 1.74 \frac{MJ}{MJ} \cdot kg = kg \qquad ( 7 )$$

On the basis of equations (1B) or (2B) and (7) the sodium or sodium hydride quantities and the associated water quantities is now calculated. The calculation initially involves the mass that is subsequently converted to volume with the density according to equation (8):

$$V = \frac{m}{ρ} {dm}^{3} = kg \cdot \frac{{dm}^{3}}{kg} \qquad ( 8 )$$

Variant A

Sodium quantity:

$$\frac{1.74}{2} \cdot 46 = 39.9 kg \cdot \frac{kg}{kg} = kg \qquad ( 9 )$$

And with (8):

$$\frac{39.9}{0.97} \cdot 41.2 kg \cdot \frac{{dm}^{3}}{kg} = {dm}^{3} \qquad ( 10 )$$

Water Quantity:

$$\frac{1.74}{2} \cdot 36 = 31.3 \frac{kg}{kg} \cdot kg = kg \qquad ( 11 )$$

And with (8):

$$\frac{31.3}{1.0} = 31.3 kg \cdot \frac{{dm}^{3}}{kg} = liters \qquad ( 12 )$$

Variant B

Sodium Hydride Quantity:

$$\frac{1.74}{2} \cdot 24 = 20.9 \frac{kg}{kg} \cdot kg = kg \qquad ( 13 )$$

And with (8):

$$\frac{20.9}{1.39} = 15.0 kg \cdot \frac{{dm}^{3}}{kg} = liters \qquad ( 14 )$$

### Water Quantity:

$$\frac{1.74}{2} \cdot 18 = 15.7 \frac{kg}{kg} \cdot kg = kg \qquad ( 15 )$$

And with (8):

$$\frac{15.7}{1.0} = 15.7 kg \cdot \frac{{dm}^{3}}{kg} = liters \qquad ( 16 )$$

The water quantities specified in equations (12) and (16) are calculated for the formation of caustic soda (sodium hydroxide, NaOH). This substance however is solid at room temperature. In surplus water it dissolves into (liquid) sodium hydroxide. Because this caustic solution has to be re-thickened before the recycling process, it makes sense to work with high concentrations.

FIG. 1 shows the solubility of caustic soda in water. Thus at an operating temperature of 70 degrees Celsius ca. 2.5 kg caustic soda is dissolved in one litre of water.

The resulting quantities of sodium hydroxide can be calculated with equations (9) and (13). With the details just provided the necessary additional water quantity can then be calculated.

Variant A

Resulting Quantity of NaOH:

$$39.9 \cdot \frac{80}{46} = 69.4 kg \cdot \frac{kg}{k Mol} \cdot \frac{k Mol}{kg} = kg \qquad ( 17 )$$

Additional Water Quantity Required:

$$\frac{69.4}{2.5} = 27.8 kg \cdot \frac{{dm}^{3}}{kg} = liters \qquad ( 18 )$$

Variant B:

Resulting Quantity of NaOH:

$$20.9 \cdot \frac{80}{48} = 34.8 kg \cdot \frac{kg}{k Mol} \cdot \frac{k Mol}{kg} = kg \qquad ( 19 )$$

Additional Water Quantity Required:

$$\frac{34.8}{2.5} = 13.9 kg \cdot \frac{{dm}^{3}}{kg} = liters \qquad ( 20 )$$

With equations (12) and (18) or equations (16) and (20) we obtain the total water quantities required:

Variant A:

31.3 litres+27.8 litres=59.1 (21)

Variant B

15.7 litres+13.9 litres=29.6 litres (22)

With equations (10) and (21) or equations (14) and (22) the following statements can then be made with regard to the volumes in comparison with the 6 litres of diesel fuel:

Variant A

For this procedure with sodium, the requirement in comparison with diesel fuel at normal pressure and normal temperature is around 7 times tank volume for sodium and around 10 times tank volume for water.

Variant B

For this procedure with sodium hydride, the requirement in comparison with diesel fuel at normal pressure and normal temperature is around 2.5 times tank volume for sodium hydride and around 5 times tank volume for water.

A calorific value of 40 MJ/kg for diesel fuel is used as prototypical here.

Comparative Calculation for Generating Electricity with Solar Energy

Using solar panels as much electrical energy as possible is generated. The surplus can then be delivered for sodium hydroxide electrolysis (see above) and thus stored. This thus forms a buffer between the total energy generated and the total consumed. In the winter months, if solar radiation is low, the reserves built in summer can be used up. FIG. 2 illustrates this relationship:

Table 2 below gives information on the energy radiated in Switzerland in recent years:

TABLE 2
Energy radiated per month in Bern from 2010 to 2014 inclusive
Unit: MJ/m²

| | Year | | | | | |
|---|---|---|---|---|---|---|
| Month | 2010 | 2011 | 2012 | 2013 | 2014 | Average |
| January | 3.8 | 4.1 | 3.5 | 4.1 | 3.9 | 3.9 |
| February | 7.0 | 7.1 | 8.5 | 7.1 | 6.8 | 7.3 |
| March | 11.5 | 12.3 | 15.4 | 9.1 | 13.8 | 12.4 |
| April | 18.8 | 20.4 | 13.5 | 13.7 | 16.3 | 16.5 |
| May | 15.5 | 22.7 | 21.6 | 15.8 | 19.3 | 19.0 |
| June | 20.2 | 19.6 | 21.5 | 22.5 | 25.3 | 21.8 |
| July | 22.4 | 21.0 | 21.6 | 24.4 | 17.7 | 21.4 |
| August | 16.7 | 20.9 | 20.1 | 20.7 | 17.1 | 19.1 |
| September | 15.0 | 15.3 | 12.2 | 13.9 | 15.2 | 14.3 |
| October | 7.6 | 9.8 | 8.1 | 7.7 | 9.2 | 8.5 |
| November | 4.6 | 5.3 | 4.3 | 4.1 | 4.2 | 4.5 |
| December | 3.6 | 2.8 | 3.5 | 4.7 | 3.0 | 3.5 |
| Total | 146.7 | 161.3 | 153.7 | 147.7 | 151.9 | 152.2 |

The calculation below now shows what potential there is in this form for energy recovery:

TABLE 3

| | |
|---|---|
| Gross national energy consumption in recent years | 1,150,000 TJ |
| Less energy generated with hydropower | −130,000 TJ |
| Less renewable energies generation | −114,000 TJ |
| Total | 906,000 TJ |

Based on the above, the surface area required to generate this energy can be calculated:

906*10¹⁵ J/(150*10⁶ J/m²)=6040 km²

Compared with the total surface area of Switzerland (41,284 km²) we arrive at the following value:

6040 km²141,284 km²=14.6%

In other words:

In order to completely replace the demand for energy generated in Switzerland with fossil fuels and nuclear energy, for a hypothetical 100% efficiency of the panels, around 15% of our country's surface area would have to be covered with solar panels.

These figures give cause for a great deal of optimism.

### Second Design Example

Another combination suitable for reversible hydrogen storage is magnesium dihydride MgH₂, also called magnesium hydride.

The following equation applies for the formation of magnesium dihydride:

Mg+H₂→MgH₂+74 kJ (23)

The following is known from reference [1]:

In its less reactive, macrocrystalline form, magnesium dihydride MgH₂ is available from its elements at 500° C. and 200 bar. In addition, the substance in microcrystalline form is described as “activated MgH₂”, which can be represented by catalytic reaction at lower pressure. However, this form is so reactive that the substance ignites in air.

MgH₂ presents a white, solid, non-liquid body, not soluble in organic mediums with very polar bonds, whose density (1.45 g/cm3) is lower than that of Mg (1.74 g/cm³).

Magnesium dihydride (MgH₂) reacts violently with water during hydrogen development and depending on the type of production is stable in air or self-igniting (“activated MgH₂”). In higher temperatures it disintegrates into elements (pH₂=1 atm at 284° C.), whereupon catalytically generated MgH₂ passes into pyrophoric magnesium, suitable for “H₂ storage”.

Application. It is capable of taking up more hydrogen (7.66% weight) than all tanks known until now, so that the energy density achievable with magnesium (9000 kJ/kg) is very high (charging greater than in liquid hydrogen).

Below are the calculations of the resulting:

| | | | Calorific value |
|---|---|---|---|
| Substance | Molar number | Density (g/cm³⁾ | (MJ/kg) |
| Mg | 24 | 1.74 | |
| H₂ | 2 | | 121 |
| MgH₂ | 26 | 1.45 | |
| Oil | | 0.94 | 42.1 |

From equation (23) we can derive the equation for the substance quantities:

$${MgH}_{2} \to Mg + {H}_{2} \\ 26 kg 24 kg 2 kg \qquad ( 24 )$$

Equation (8) leads us to the volume of the source material:

$$V = \frac{26 kg {dm}^{3}}{1.45 kg} = 17.9 {dm}^{3} \qquad ( 25 )$$

Burning 2 kg of hydrogen releases 242 MJ. This corresponds to a quantity of 242 MJ/42.1 MJ/kg=5.7 kg oil.

In turn we can calculate the volumes of 5.7 kg oil with (8):

$$V = \frac{5.7 kg {dm}^{3}}{0.94 kg} = 6.1 {dm}^{3} \qquad ( 26 )$$

By comparing (25) and (26) we get a factor of:

17.9 dm³/6.1 dm³=2.9 (27)

Thus the volume required for the source material is 3 times below that of oil.

This variant has the advantage over those described above that the electrolysis of the hydroxide is avoided, because it does not arise. After release of the hydrogen (this takes place—as described—at normal pressure and a temperature of 284° C.), magnesium is again present in elementary form. Together with hydrogen, this can once again be synthesised into MgH₂ (e.g. catalytically or under pressure).

The hydrogen required for this can be obtained by electrolysis of water. This is substantially easier than conducting fused-salt electrolysis of a hydroxide, one reason being that it can be carried out at room temperature.

Modifications and additions are available to the specialist from the preceding description, without abandoning the invention's scope of protection specified by the claims.

The following in particular is possible:
Other proton-delivering fluids are used instead of water or in admixture, preferably lower alcohol such as methanol or ethanol. Alcohols particularly regarded as lower alcohol are those with 1 to 4 carbon atoms.
Hydrogen is used to operate a vehicle, to heat buildings or (chemical) reactors, to generate electricity, especially in thermal power stations, or in electrochemical cells.
In a vehicle the sodium components (sodium or sodium hydride) are in a first tank and the proton-delivering liquid is in a second. Adding the liquid to the first tank releases hydrogen. The substances can also be mixed in a reaction chamber, from which the products of the reaction are carried into a third tank which receives the other products of the reaction, especially the sodium hydroxide or caustic soda. The chambers can also be combined as one unit, e.g. the reaction chamber can form one unit with the first and third tanks. In this design the liquid must be carried into the reaction chamber and the non-gaseous products of the reaction remain in it. In this way there is no need to transport the products of the reaction into the separate third tank.
Use of other metals or metal hydrides, including in admixture with each other or with sodium, which react spontaneously with whichever proton-delivering fluid is used in releasing hydrogen. Especially possible are generally alkaline metals generally, including lithium (Li) and potassium (K) preferred for reasons of cost, and alkaline earth metal hydrides, preferably calcium hydride and magnesium dihydride.
The conditions under which metal or metal hydride and proton-delivering liquid are brought into contact are controlled, so that a spontaneous reaction takes place. The temperature in particular is set.
A hydride other than magnesium dihydride is used in the thermolytic release of hydrogen (release through heating). The decomposition temperature is selected according to the hydride.
The volume of a metal hydride from which hydrogen can be released with a raised temperature is not more than 5 times, and preferably not more than 3.5 times, the volume of a fuel with 40 MJ/kg calorific value, in order to release a volume of hydrogen of the same calorific value as the fuel.

### REFERENCES

[1] Lehrbuch der Anorganischen Chemie [textbook of inorganic chemistry] Hollemann Wiberg, 102nd edition
ISBN 978-3-11-017770-1
[2] Technische Formelsammlung [technical formulas]
Gieck Verlag GmbH, 31 expanded edition
ISBN 3 92037925 X
[3] CRC Handbook of Chemistry and Physics
W. M. Haynes, 95th edition
ISBN 978-1-4822-0867-2
[4] Statistisches Jahrbuch der Schweiz [Swiss statistical yearbook]
2013 Verlag Neue Zürcher Zeitung
ISBN 978-3-0 38 23-81 4-0
[5] Eidgenossisches Departement des Innern [Federal Department of Home Affairs] EDI
Bundesamt für Meteorologie und Klimatologie [Federal Office of Meteorology and Climatology] MeteoSchweiz

1-13. (canceled)

14. A method for releasing hydrogen as an energy source comprising contacting a proton-delivering liquid with at least one metal hydride at a temperature that provides a spontaneous reaction between the proton-delivering liquid and the at least one metal hydride, resulting in the release of hydrogen for use as an energy source.

15. The method of claim 14, wherein the at least one metal hydride is selected from lithium hydride, sodium hydride, potassium hydride, magnesium dihydride, and/or calcium hydride.

16. The method of claim 15, wherein the said at least one metal hydride is sodium hydride.

17. The method of claim 15, wherein the said at least one metal hydride is magnesium dihydride.

18. The method of claim 17, wherein the magnesium dihydride is macrocrystalline magnesium dihydride.

19. The method of claim 1, wherein the metal hydride is magnesium dihydride and the temperature for spontaneous reaction to release hydrogen is about 250° C. to about 284° C.

20. The method of claim 19, wherein the temperature for spontaneous reaction to release hydrogen is about 284° C.

21. The method of claim 14, wherein the proton-delivering liquid is water and/or a lower alkyl alcohol, wherein the lower alkyl alcohol is a 1 to 4 carbon atom alcohol.

22. The method of claim 19, wherein proton-delivering liquid is methanol and/or ethanol.

23. The method of claim 14, wherein the proton-delivering liquid is methanol and/or ethanol and the at least one metal hydride is macrocrystalline magnesium dihydride.

24. The method of claim 14, further comprising a volume of metal hydride and proton-delivering liquid, wherein the volume of the metal hydride and the proton-delivering liquid is less than 8 times the volume of a hydrocarbon fuel with a calorific value of 40 MJ/kg.

25. The method of claim 14, further comprising a volume of metal hydride, wherein the volume of metal hydride is less than 5 times the volume of a hydrocarbon fuel with a calorific value of 40 MJ/kg.

26. The method of claim 14, further comprising a volume of metal hydride, wherein the volume of metal hydride is less than 3.5 times the volume of a hydrocarbon fuel with a calorific value of 40 MJ/kg.

27. The method of claim 1, wherein the resultant proton-delivering liquid and the at least one metal hydride product formed from the spontaneous reaction is subjected to an electrolysis procedure to produce at least one metal hydride.

28. The method of claim 27, wherein the electric power for the electrolysis is generated from a renewable energy source.

29. The method of claim 28, wherein the renewable energy source is a solar energy collecting panel.

30. The method of claim 1, wherein the for use as an energy source is for combustion engines in motor vehicles, heating buildings or reactors, reactors in the chemical industry, power generation in thermal power stations, and/or electrochemical application in fuel cells.

31. A method for releasing hydrogen as an energy source comprising heating at least one metal hydride at a temperature that spontaneously releases hydrogen for use as an energy source.

32. The method of claim 31, wherein the at least one metal hydride is magnesium dihydride and the temperature for spontaneous release of hydrogen is about 250° C. to about 284° C.

33. The method of claim 31, wherein the temperature for spontaneous reaction to release hydrogen is about 284° C.

34. A vehicle comprising a first tank for storing at least one metal hydride, a second tank for storing a proton-delivering liquid, a third tank for storing the resultant at least one metal hydride and proton-delivering liquid product formed by the release of hydrogen, and a reaction chamber; wherein the at least one metal hydride in the first tank and the proton delivering liquid in the second tank are connected to the reaction chamber, where the connection allows transfer of the at least one metal hydride in the first tank and the proton-delivering liquid in the second tank into the reaction chamber, where the at least one metal hydride and the proton-delivering liquid react to spontaneously release hydrogen and the resultant at least one metal hydride and proton-delivering liquid product in the reaction chamber is transferred to the third tank which is also connected to the reaction chamber; wherein the released hydrogen is used as an energy source for a combustion engine in the vehicle.

35. The vehicle of claim 34, wherein the at least one metal hydride and the proton-delivering liquid are reacted at increasing temperatures to spontaneously release hydrogen.

36. The vehicle of claim 34, wherein the reaction chamber is part of the first and third tanks.

37. The vehicle of claim 34, wherein the first tank 1, the third tank, and the reaction chamber comprise a single unit that is configured such that the metal hydride and the resultant at least one metal hydride and proton-delivering liquid product formed by the release of hydrogen are not transferred between a separate first tank and separate the third tank, and the reaction chamber.

38. The vehicle of claim 34, wherein the at least one metal hydride is sodium hydride or magnesium dihydride.

39. The vehicle of claim 38, wherein the at least one metal hydride is sodium hydride.

40. The vehicle of claim 38, wherein the at least one metal hydride is magnesium dihydride.

41. The vehicle of claim 40, wherein the magnesium dihydride is macrocrystalline magnesium dihydride.

42. The vehicle of claim 34, wherein the proton-delivering liquid is water and/or a lower alkyl alcohol, wherein the lower alkyl alcohol is a 1 to 4 carbon atom alcohol.

43. The vehicle of claim 42, wherein proton-delivering liquid is methanol and/or ethanol.

44. A method for releasing hydrogen as an energy source comprising contacting a proton-delivering liquid with at least one elemental metal at a temperature that provides a spontaneous reaction between the proton-delivering liquid and the at least one elemental metal, resulting in the release of hydrogen for use as an energy source.

45. The method of claim 44, wherein the at least one elemental metal is selected from lithium, sodium, and/or potassium.

46. The method of claim 44 further comprising at least one metal hydride.

47. The method of claim 46, wherein the at least one metal hydride is selected from lithium hydride, sodium hydride, potassium hydride, magnesium dihydride, and/or calcium hydride.
